(19) United States
(12) Patent Application Publication
(10) Pub. No.: US 2014/0373670 A1
(43) Pub. Date: Dec. 25, 2014

(54) BIKE HANDLE FIXING DEVICE

(71) Applicant: SIENNA GROUP CORPORATION, Taichung City (TW)

(72) Inventors: YAO-CHING HUANG, Taichung City (TW); ZONG-BIN XIAO, Taichung City (TW)

(21) Appl. No.: 13/926,080

(22) Filed: Jun. 25, 2013

(51) Int. Cl. B62K 21/12

(52) U.S. Cl. CPC B62K 21/12
USPC 74/551.1

(57) ABSTRACT

A bike handle fixing device includes a connecting unit, a fixing unit and at least one locking member. The connecting unit has two connecting ends. The fixing unit includes a main body having a smooth outer surface, a fixing trough and a guide tongue. The locking member is to connect the connecting unit and the fixing unit for clamping a bike handle. The fixing device of present invention can improve the quality, lower the wind resistance, facilitate engagement and save the parts and assembly time.

### BACKGROUND OF THE INVENTION

1. Field of the Invention

The present invention relates to a bike handle fixing device which can improve the quality, lower the wind resistance, facilitate engagement and save the parts and assembly time.

2. Description of the Prior Art

Referring to FIG. 1 and FIG. 2, a conventional bike handle fixing device comprises a connecting unit 60, a fixing unit 70 and at least one locking member 80.

The connecting unit 60 has a first connecting end 60A and an opposing second connecting end 60B. The first connecting end 60A is adapted for connecting a bike upright pipe. The second connecting end 60B has a receiving trough 61. The receiving trough 61 has a pair of fixing holes 611. The fixing unit 70 has a fixing trough 71 corresponding in position to the receiving trough 61. The fixing trough 71 has locking holes 711 corresponding to the fixing holes 611. The locking member 80 is inserted through the fixing holes 611 and locked to the locking holes 711 so that the receiving trough 61 and the fixing trough 71 are used to clamp a bike handle 90.

The screws are exposed out of the surface of the conventional fixing device. This not only influences the appearance but also causes the wind resistance. Besides, the fixing device has many parts to consume assembly time.

Accordingly, the inventor of the present invention has devoted himself based on his many years of practical experiences to solve these problems.

### SUMMARY OF THE INVENTION

The primary object of the present invention is to provide a bike handle fixing device which can improve the quality, lower the wind resistance, facilitate engagement and save the parts and assembly time. The present invention can improve the aforesaid shortcomings of the prior art.

In order to achieve the aforesaid object, the bike handle fixing device of the present invention comprises a connecting unit, a fixing unit and at least one locking member.

The connecting unit has a first connecting end and an opposing second connecting end. The first connecting end is adapted for connecting a bike upright pipe. The second connecting end has an engaging hole and a receiving trough. The engaging hole has an engaging face therein. The receiving trough extends outward from the engaging hole and has at least one fixing hole.

The fixing unit has a main body, a fixing trough and a guide tongue. The main body has a smooth outer surface. The fixing trough is disposed on the main body and opposing the smooth outer surface. The fixing trough corresponds in position to the receiving trough. The fixing trough has a locking hole corresponding to the fixing hole. The guide tongue extends out and horizontally from the fixing trough. When the guide tongue guides the main body to enter the engaging hole, the guide tongue engages with the engaging face to enhance connection of the connecting unit and the fixing unit.

The locking member is inserted through the fixing hole and locked to the locking hole so that the receiving trough and the fixing trough are used to clamp a bike handle.

### BRIEF DESCRIPTION OF THE DRAWINGS

FIG. 1 is an exploded view of a conventional fixing device;

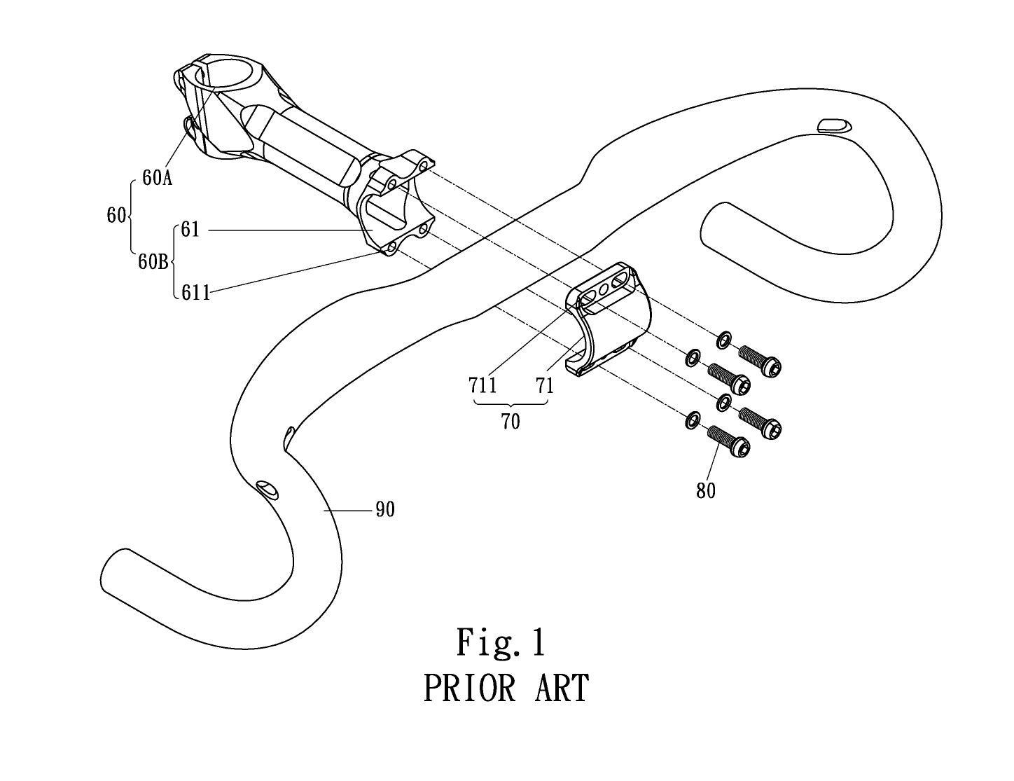

FIG. 2 is a perspective view of FIG. 1;

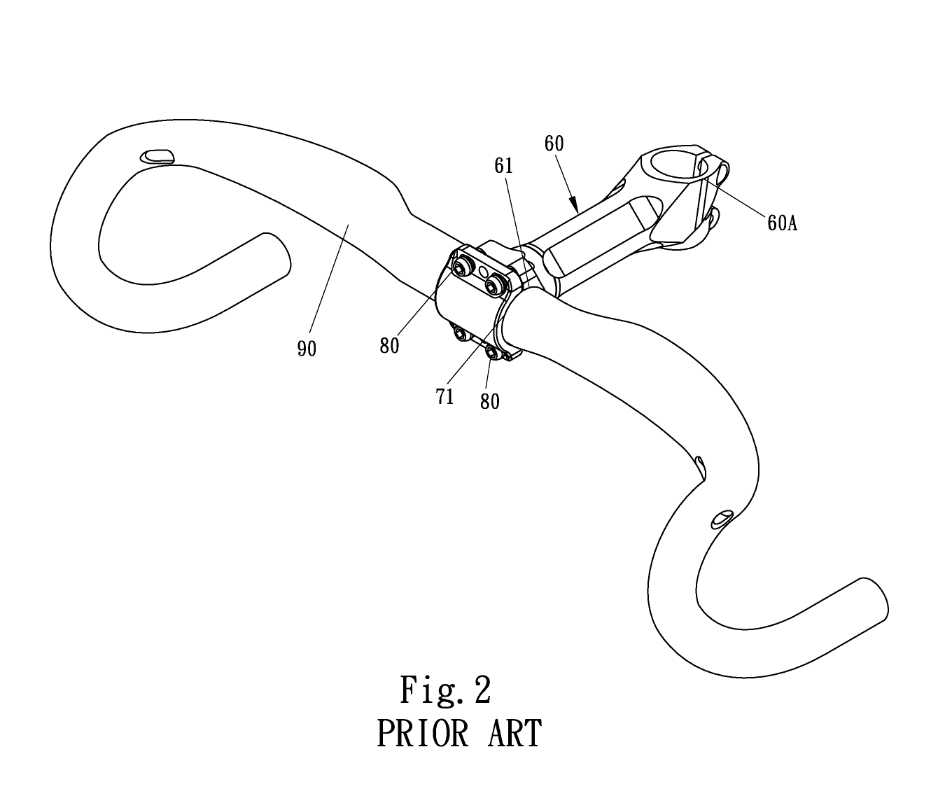

FIG. 3 is an exploded view of the present invention;

FIG. 4 is a sectional view of FIG. 3 when assembled;

FIG. 5 is a sectional view of FIG. 4 after assembled;

FIG. 6 is a sectional view of FIG. 5 after assembled and locked;

FIG. 7 is another sectional view after assembled; and

FIG. 8 is a perspective view of the present invention after assembled.

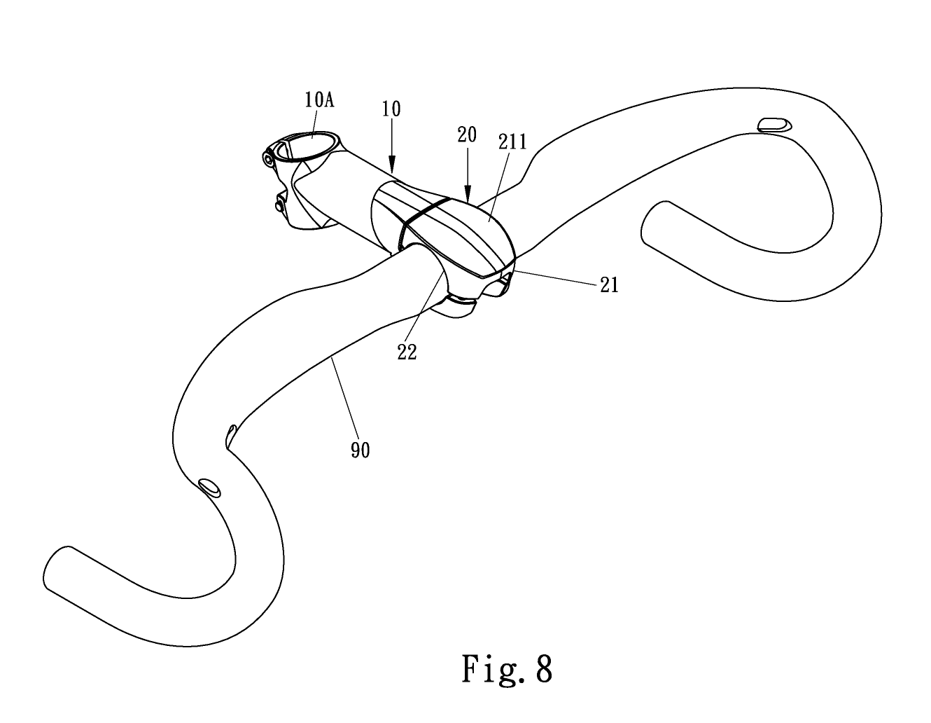

### DETAILED DESCRIPTION OF THE PREFERRED EMBODIMENTS

Embodiments of the present invention will now be described, by way of example only, with reference to the accompanying drawings.

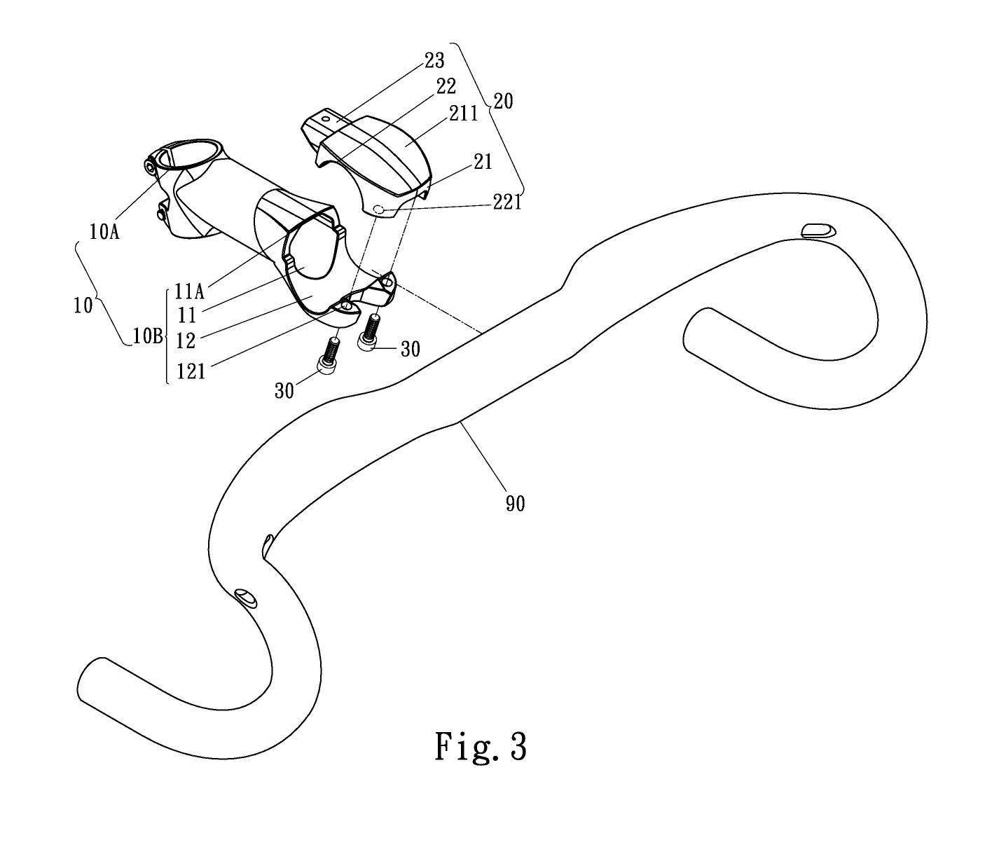

Referring to FIG. 3, the bike handle fixing device according to a preferred embodiment of the present invention comprises a connecting unit 10, a fixing unit 20 and at least one locking member 30.

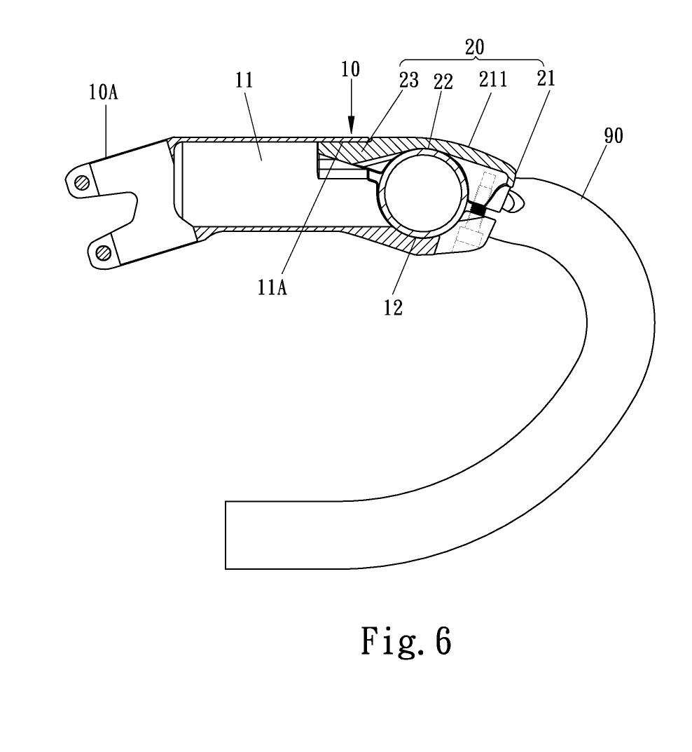

The connecting unit 10 has a first connecting end 10A and an opposing second connecting end 10B. The first connecting end 10A is adapted for connecting a bike upright pipe. The second connecting end 10B has an engaging hole 11 and a receiving trough 12. The engaging hole 11 has an engaging face 11A therein, referring to FIG. 6. The receiving trough 12 extends outward from the engaging hole 11 and has at least one fixing hole 121.

The fixing unit 20 has a main body 21, a fixing trough 22 and a guide tongue 23. The main body 21 has a smooth outer surface 211. The fixing trough 22 is disposed on the main body 21 and opposing the smooth outer surface 211. The fixing trough 22 corresponds in position to the receiving trough 12. The fixing trough 22 has a locking hole 221 corresponding to the fixing hole 121. The guide tongue 23 extends out and horizontally from the fixing trough 22. When the guide tongue 23 guides the main body 21 to enter the engaging hole 11, the guide tongue 23 will engage with the engaging face 11A to enhance connection of the connecting unit 10 and the fixing unit 20.

The locking member 30 is inserted through the fixing hole 121 and locked to the locking hole 221 so that the receiving trough 12 and the fixing trough 22 can be used to clamp a bike handle 90.

When in use, the first connecting end 10A is used to connect a bike upright pipe (not shown in the drawings).

The receiving trough 12 and the fixing trough 22 are used to clamp the bike handle 90.

The smooth outer surface 211 can lower the wind resistance of the bike handle fixing device when riding.

The smooth outer surface 211 can beautify the appearance of the bike handle fixing device when riding, without screws seen.

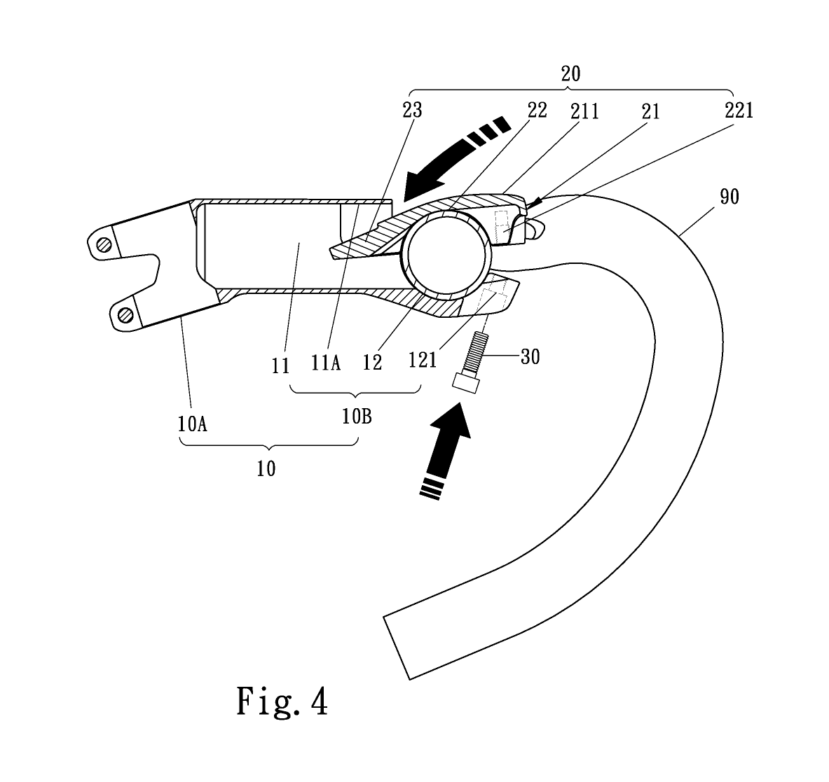

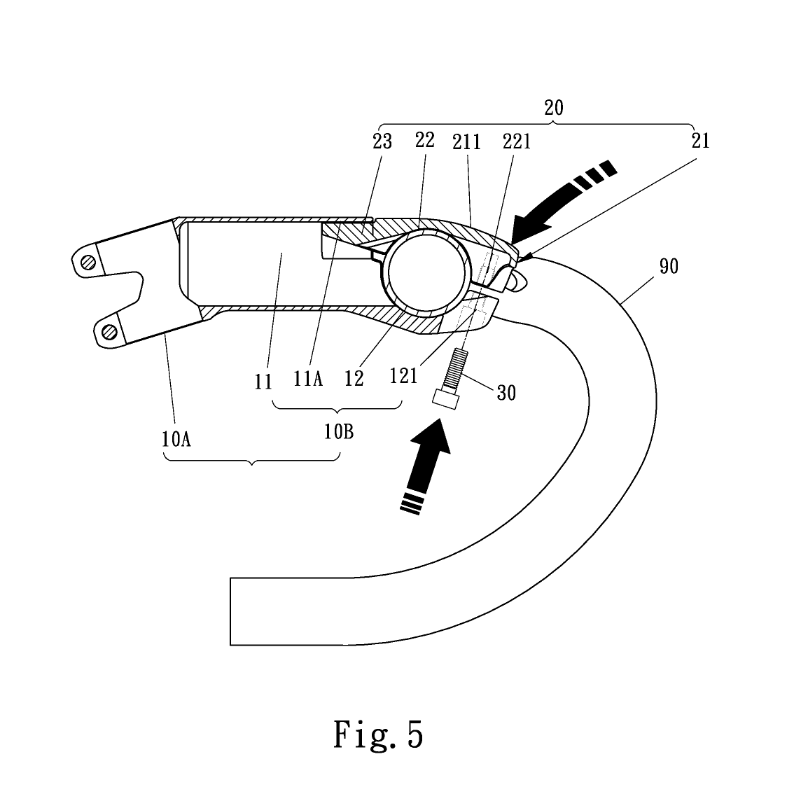

Referring to FIG. 4 and FIG. 5, the bike handle 90 is first placed on the receiving trough 12. After that, the fixing unit 20 is inserted in the engaging hole 11 of the second connecting end 10B through the guide of the guide tongue 23, and pressed downward until the guide tongue 23 engages with the engaging face 11A of the engaging hole 11. Finally, the locking member 30 is inserted through the fixing hole 121 and locked to the locking hole 221.

At this time, the fixing unit 20 brings the following two motions.

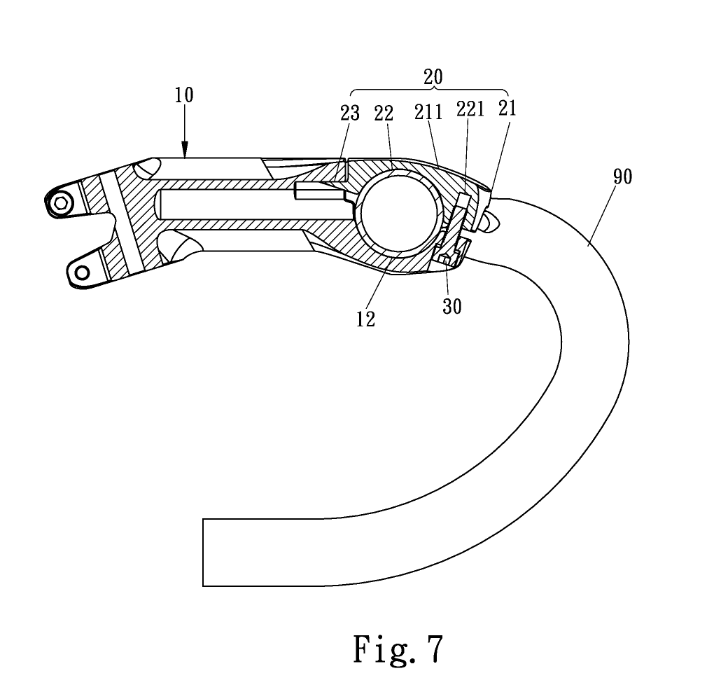

A. Lock: The receiving trough 12 and the fixing trough 22 are adapted to clamp and position the bike handle 90, referring to FIG. 6 and FIG. 7.

B. Engagement: The guide tongue 23 engages with the engaging face 11A so there is no need for screws between the second connecting end 10B and the fixing unit 20. The strength of connection between the connecting unit 10 and the fixing unit 20 can be enhanced.

The present invention has the following advantages:

1. Improving quality: The smooth outer surface of the fixing unit can beautify the appearance of the bike handle fixing device when riding, without screws seen.

2. Lowering the wind resistance: The smooth outer surface of the fixing unit not only provides a better visual effect but also lowers the wind resistance when riding.

3. Assisting engagement: The guide tongue engages with the engaging face to assist in connecting the second connecting end with the fixing unit. The strength of connection between the connecting unit and the fixing unit is enhanced.

4. Saving the parts and the assembly time. Through the engaging tongue to engage with the second connecting end, the present invention can save the parts and assembly time.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bike handle fixing device, comprising a connecting unit, a fixing unit and at least one locking member;
the connecting unit having a first connecting end and an opposing second connecting end, the first connecting end being adapted for connecting a bike upright pipe, the second connecting end having an engaging hole and a receiving trough, the engaging hole having an engaging face therein, the receiving trough extending outward from the engaging hole and having at least one fixing hole;
the fixing unit having a main body, a fixing trough and a guide tongue, the main body having a smooth outer surface, the fixing trough being disposed on the main body and opposing the smooth outer surface, the fixing trough corresponding in position to the receiving trough, the fixing trough having a locking hole corresponding to the fixing hole, the guide tongue extending out and horizontally from the fixing trough, wherein, when the guide tongue guides the main body to enter the engaging hole, the guide tongue engages with the engaging face to enhance connection of the connecting unit and the fixing unit;
the locking member being inserted through the fixing hole and locked to the locking hole so that the receiving trough and the fixing trough are used to clamp a bike handle.
